(19) United States
(12) Patent Application Publication
(10) Pub. No.: US 2013/0268485 A1
(43) Pub. Date: Oct. 10, 2013

(54) Methods, Apparatus and Computer Program Products for Providing Automatic and Incremental Mobile Application Recognition

(71) Applicants: Huanhuan Cao, Beijing (CN); Jilei Tian, Beijing (CN)

(72) Inventors: Huanhuan Cao, Beijing (CN); Jilei Tian, Beijing (CN)

(73) Assignee: NOKIA CORPORATION, Espoo (FI)

(21) Appl. No.: 13/994,832

(22) PCT Filed: Dec. 23, 2010
(86) PCT No.: PCT/CN10/80169

§ 371 Date: Jun. 17, 2013

(51) Int. Cl. G06F 17/30

(52) U.S. Cl. CPC G06F 17/30289; G06F 17/30345
USPC 707/609; 707/722

(57) ABSTRACT

An apparatus for automatically recognizing the semantics of one or more mobile applications may include a processor and a memory storing executable computer program code that cause the apparatus to at least perform operations including receiving an indication of a selection of at least one mobile application. The computer program code may further cause the apparatus to enable provision of a request, to a device, requesting the device to search indicia associated with the selected mobile application in an instance in which a determination indicates that the selected mobile application is not identified in an application mapping list. The computer program code may further cause the apparatus to assign a semantic tag to the selected mobile application based in part on data associated with a description generated based in part by extracting content from one or more results of the search. Corresponding methods and computer program products are also provided,

### TECHNOLOGICAL FIELD

An example embodiment of the invention relates generally to mobile application technology, and more particularly, relates to a method, apparatus, and computer program product for automatically recognizing the semantics of one or more mobile applications to ease system processing.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. Due to the now ubiquitous nature of electronic communication devices, people of all ages and education levels are utilizing electronic devices to communicate with other individuals or contacts, receive services and/or share information, media and other content. One area in which there is a demand to increase ease of information transfer relates to service providers developing mobile applications for usage by communication devices. The usage of the mobile applications by a user of a communication device may be analyzed to understand user behavior and context modeling for understanding the user's behavior and preferences.

In this regard, usage of mobile applications may serve as beneficial context information for understanding a user's preference in personalized context-aware services. For example, a segmentation that the user belongs to may be identified for a mobile user based on data associated with the user's frequently used mobile applications. By analyzing data associated with the user's mobile applications and other context information, the habits of the user may be identified. However, the information associated with the usage of mobile applications may only be useful if the semantic information associated with the history data of a mobile application's usage may be recognized. In this regard, the semantic information may be needed to determine the type of a mobile application(s) and the context related to a mobile application(s).

However, currently it may be difficult to recognize the semantic meaning of all mobile applications available for mobile devices. For instance, with the popularity of smart phones, the number of mobile applications may be hundreds of thousands which may make it difficult to identify the semantic information associated with all mobile applications that may be utilized to identify the type of a mobile application and for understanding preferences of a user associated with a history log relating to a user application interaction. In this regard, at present some smart phones may support more than 200,000 mobile applications and the number of mobile applications continues to increase at a fast pace.

Additionally, currently it may be expensive and require much effort to manually annotate all of the existing mobile applications and to generate a mapping list identifying all mobile applications that may be used by mobile devices. In addition, mobile applications annotated by individuals may result in inconsistencies and errors. Also, the development speed of new mobile applications is typically faster due to the well-developed tools and business models. As such, a periodic manual update of mobile applications may not satisfy a requirement of recognizing new mobile applications in a timely manner. Moreover, although some existing mobile applications are associated with semantic information, the semantic information may be too inaccurate for usage in understanding the preferences of a user. For example, a mobile application relating to a security application may be tagged with metadata as relating to a business, which may be too inaccurate to determine a user's preferences since the mobile application corresponds to security. Additionally, many mobile applications are currently still not associated with any semantic information and as such these mobile applications may not be useful for determining preferences and interests of a user.

In view of the foregoing drawbacks, it may be beneficial to provide a mechanism for automatically recognizing mobile applications and corresponding semantic information in a manner that minimizes the consumption of resources.

### BRIEF SUMMARY

A method, apparatus and computer program product are therefore provided for automatically recognizing one or more mobile applications in an efficient and reliable manner. An example embodiment may be configured to map one or more known mobile applications to corresponding semantic tags in an application mapping list. The application mapping list may, but need not, be predefined and may include data associated with the most popular mobile applications corresponding to one or more respective categories. An example embodiment may assign a semantic tag to an unknown or unrecognized mobile application according to a text based description that may be based on data extracted from search results, as described more fully below.

For example, in an instance in which a user of an apparatus selects a mobile application for execution, an example embodiment may determine whether the selected mobile application is identified in the application mapping list. In an instance in which the selected mobile application is identified in the application mapping list, an example embodiment may directly output a semantic tag corresponding to the selected mobile application. The output the semantic tag may be utilized by an example embodiment to analyze a user's daily usage of mobile applications, determine one or more preferences of the user, generate one or more recommendations for consideration by the user or perform any other suitable action based in part on analyzing the semantic tag.

On the other hand, in an instance in which an example embodiment determines that the selected mobile application is not identified in the application mapping list, an example embodiment may submit indicia (e.g., a name) associated with the selected mobile application to a network device. In this regard, an example embodiment may request the network device to search the indicia associated with the selected mobile application in order to obtain additional information regarding the selected mobile application.

As such, an example embodiment may receive results of the search from the network device and may collect one or more snippets associated with the received results. The snippets may be processed to generate a description of the selected mobile application. Based on the generated description of the selected mobile application, an example embodiment may assign a semantic tag to the selected mobile application. The semantic tag may denote a meaning associated with the selected mobile application. For example, the semantic tag may be associated with a category of a taxonomy. An example embodiment may include the assigned semantic tag and the selected mobile application in the application mapping list to obtain a new or updated application mapping list. By including the selected mobile application and the assigned semantic tag in the updated application list, an example embodiment may recognize the selected mobile application in an instance in which the mobile application is subsequently selected or executed based on analyzing data of the updated application mapping list. An example embodiment may output the assigned semantic tag and may utilize data associated with the semantic tag to analyze a user's daily usage of mobile applications, determine one or more preferences of the user, generate one or more recommendations for consideration by the user or perform any other suitable action based in part on analyzing the assigned semantic tag.

An example embodiment may provide an efficient and reliable manner in which to map mobile applications to one or more respective semantic tags, from which the behavior and preferences of multiple users of communication devices may be derived. By utilizing an example embodiment of the invention, mobile applications may be detected automatically and as such the burden associated with a user tagging mobile applications to associate a meaning to the mobile applications may be minimized or avoided. Additionally, an example embodiment may automatically assign semantic tags to unknown or previously unrecognized mobile applications in a manner that minimizes an impact on computing resources (e.g., bandwidth, memory, processing capability, etc.) and costs.

In one example embodiment, a method for automatically recognizing the semantics of one or more mobile applications is provided. The method may include receiving an indication of a selection of at least one mobile application. The method may further include enabling provision of a request, to a device, requesting the device to search indicia associated with the selected mobile application in an instance in which a determination indicates that the selected mobile application is not identified in an application mapping list. The method may further include assigning a semantic tag to the selected mobile application based in part on data associated with a description. The description may be generated based in part by extracting content from one or more results of the search.

In another example embodiment, an apparatus for automatically recognizing the semantics of one or more mobile applications is provided. The apparatus may include a processor and a memory including computer code. The memory and the computer program code are configured to, with the processor, cause the apparatus to at least perform operations including receiving an indication of a selection of at least one mobile application. The memory and the computer program code may further cause the apparatus to enable provision of a request, to a device, requesting the device to search indicia associated with the selected mobile application in an instance in which a determination indicates that the selected mobile application is not identified in an application mapping list. The memory and the computer program code may further cause the apparatus to assign a semantic tag to the selected mobile application based in part on data associated with a description. The description may be generated based in part by extracting content from one or more results of the search.

In another example embodiment, a computer program product for automatically recognizing the semantics of one or more mobile applications is provided. The computer program product includes at least one computer-readable storage medium having computer executable program code instructions stored therein. The computer executable program code instructions may include program code instructions configured to enable receipt of an indication of a selection of at least one mobile application. The program code instructions may also be configured to enable provision of a request, to a device, requesting the device to search indicia associated with the selected mobile application in an instance in which a determination indicates that the selected mobile application is not identified in an application mapping list. The program code instructions may also be configured to assign a semantic tag to the selected mobile application based in part on data associated with a description. The description may be generated based in part by extracting content from one or more results of the search.

In another example embodiment, a method for automatically recognizing the semantics of one or more mobile applications is provided. The method may include receiving an updated application mapping list from a device and utilizing at least a portion of data corresponding to one or more newly recognized mobile applications of the updated application mapping list to update a global mapping list. The method may further include enabling provision of information associated with the newly recognized mobile applications to one or more devices. The devices may include the information associated with the newly recognized mobile applications in respective application mapping lists of the devices.

In another example embodiment, an apparatus for automatically recognizing the semantics of one or more mobile applications is provided. The apparatus may include a processor and a memory including computer code. The memory and the computer program code are configured to, with the processor, cause the apparatus to at least perform operations including receiving an updated application mapping list from a device and utilizing at least a portion of data corresponding to one or more newly recognized mobile applications of the updated application mapping list to update a global mapping list. The memory and the computer program code may further cause the apparatus to enable provision of information associated with the newly recognized mobile applications to one or more devices. The devices may include the information associated with the newly recognized mobile applications in respective application mapping lists of the devices.

An embodiment of the invention may provide a method, apparatus and computer program product for employment, for example in mobile environments. As a result, for example, computing device uses may enjoy improved capability with respect to mobile applications.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a system according to an example embodiment of the invention;

FIG. 2 is a schematic block diagram of an apparatus according to an example embodiment of the invention;

FIG. 3 is a schematic block diagram of a network device according to an example embodiment of the invention;

FIG. 4 is a diagram illustrating a taxonomy according to an example embodiment of the invention;

FIG. 5 is a diagram of an application mapping list according to an example embodiment of the invention;

FIG. 6 is a diagram illustrating a system and method for automatically recognizing one or more mobile applications according to an example embodiment;

FIG. 7 is a diagram of an updated or new application mapping list according to an example embodiment of the invention;

FIG. 8 is a diagram illustrating snippets of search results according to an example embodiment of the invention; and

FIG. 9 is a flowchart of an example method for automatically recognizing one or more mobile applications according to an example embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein a “mobile application(s)” may be an application(s), software, computer code or the like that may be utilized and/or executed by one or more mobile devices. In one example embodiment, a processor of the mobile devices may execute the mobile application(s). The mobile applications may, but need not, be preinstalled on communication devices, downloaded from one or more application stores or from any suitable software distributor.

As referred to herein a “semantic tag(s)” may relate to one or more leaf nodes or categories that may be associated with a mobile application(s) and the categor(ies) may denote a meaning associated with the mobile application(s). The leaf nodes and/or categories may be arranged in a taxonomy.

As referred to herein a “snippet(s)” may relate to data associated with one or more summaries of search results associated with a Web page.

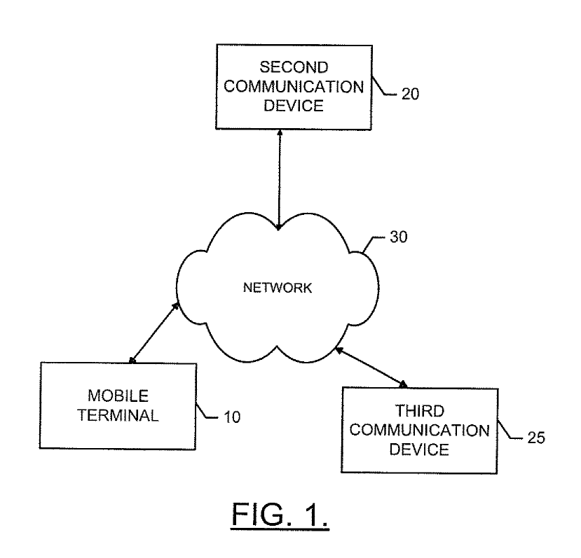

FIG. 1 illustrates a generic system diagram in which a device such as a mobile terminal 10 is shown in an example communication environment. As shown in FIG. 1, an embodiment of a system in accordance with an example embodiment of the invention may include a first communication device (e.g., mobile terminal 10) and a second communication device 20 capable of communication with each other via a network 30. In some cases, an embodiment of the present invention may further include one or more additional communication devices, one of which is depicted in FIG. 1 as a third communication device 25. In one embodiment, not all systems that employ an embodiment of the present invention may comprise all the devices illustrated and/or described herein. While an embodiment of the mobile terminal 10 and/or second and third communication devices 20 and 25 may be illustrated and hereinafter described for purposes of example, other types of terminals, such as portable digital assistants (PDAs), pagers, mobile televisions, mobile telephones, gaming devices, laptop computers, cameras, video recorders, audio/video players, radios, global positioning system (GPS) devices, Bluetooth headsets, Universal Serial Bus (USB) devices or any combination of the aforementioned, and other types of voice and text communications systems, can readily employ an embodiment of the present invention. Furthermore, devices that are not mobile, such as servers and personal computers may also readily employ an embodiment of the present invention.

The network 30 may include a collection of various different nodes (of which the second and third communication devices 20 and 25 may be examples), devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in one embodiment, the network 30 may be capable of supporting communication in accordance with any one or more of a number of First-Generation (1G), Second-Generation (2G), 2.5G, Third-Generation (3G), 3.5G, 3.9G, Fourth-Generation (4G) mobile communication protocols, Long Term Evolution (LTE) or Evolved Universal Terrestrial Radio Access Network (E-UTRAN), Self Optimizing/Organizing Network (SON) intra-LTE, inter-Radio Access Technology (RAT) Network and/or the like. In one embodiment, the network 30 may be a point-to-point (P2P) network.

One or more communication terminals such as the mobile terminal 10 and the second and third communication devices 20 and 25 may be in communication with each other via the network 30 and each may include an antenna or antennas for transmitting signals to and for receiving signals from one or more base sites. The base sites could be, for example one or more base stations (BS) that is a part of one or more cellular or mobile networks or an access point that may be coupled to a data network, such as a Local Area Network (LAN), Wireless Local Area Network (WLAN), a Metropolitan Area Network (MAN), and/or a Wide Area Network (WAN), such as the Internet. In turn, other devices such as processing elements (e.g., personal computers, server computers or the like) may be coupled to the mobile terminal 10 and the second and third communication devices 20 and 25 via the network 30. By directly or indirectly connecting the mobile terminal 10 and the second and third communication devices 20 and 25 (and/or other devices) to the network 30, the mobile terminal 10 and the second and third communication devices 20 and 25 may be enabled to communicate with the other devices or each other. For example, the mobile terminal 10 and the second and third communication devices 20 and 25 as well as other devices may communicate according to numerous communication protocols including Hypertext Transfer Protocol (HTTP) and/or the like, to thereby carry out various communication or other functions of the mobile terminal 10 and the second and third communication devices 20 and 25, respectively.

Furthermore, although not shown in FIG. 1, the mobile terminal 10 and the second and third communication devices 20 and 25 may communicate in accordance with, for example, radio frequency (RF), near field communication (NFC), Bluetooth (BT), Infrared (IR) or any of a number of different wireline or wireless communication techniques, including Local Area Network (LAN), Wireless LAN (WLAN), Worldwide Interoperability for Microwave Access (WiMAX), Wireless Fidelity (WiFi), Ultra-Wide Band (UWB), Wibree techniques and/or the like. As such, the mobile terminal 10 and the second and third communication devices 20 and 25 may be enabled to communicate with the network 30 and each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as WLAN, WiMAX, and/or the like and fixed access mechanisms such as Digital Subscriber Line (DSL), cable modems, Ethernet and/or the like.

In an example embodiment, the first communication device (e.g., the mobile terminal 10) may be a mobile communication device such as, for example, a wireless telephone or other devices such as a personal digital assistant (PDA), mobile computing device, camera, video recorder, audio/video player, positioning device, game device, television device, radio device, or various other like devices or combinations thereof. The second communication device 20 and the third communication device 25 may be mobile or fixed communication devices. However, in one example, the second communication device 20 and the third communication device 25 may be servers, remote computers or terminals such as personal computers (PCs) or laptop computers.

In an example embodiment, the network 30 may be an ad hoc or distributed network arranged to be a smart space. Thus, devices may enter and/or leave the network 30 and the devices of the network 30 may be capable of adjusting operations based on the entrance and/or exit of other devices to account for the addition or subtraction of respective devices or nodes and their corresponding capabilities.

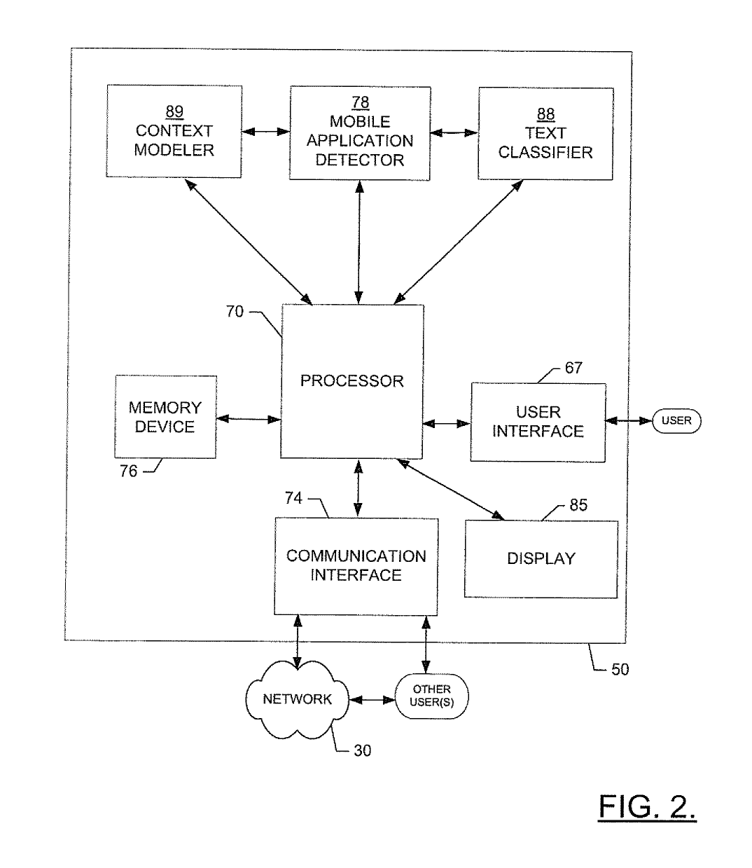

In an example embodiment, the mobile terminal as well as the second and third communication devices 20 and 25 may employ an apparatus (e.g., apparatus of FIG. 2) capable of employing an embodiment of the invention.

FIG. 2 illustrates a schematic block diagram of an apparatus for automatically detecting one or more mobile applications. An example embodiment of the invention will now be described with reference to FIG. 2, in which certain elements of an apparatus 50 are displayed. The apparatus 50 of FIG. 2 may be employed, for example, on the mobile terminal 10 (and/or the second communication device 20 or the third communication device 25). Alternatively, the apparatus 50 may be embodied on a network device of the network 30. However, the apparatus 50 may alternatively be embodied at a variety of other devices, both mobile and fixed (such as, for example, any of the devices listed above). In some cases, an embodiment may be employed on a combination of devices. Accordingly, one embodiment of the invention may be embodied wholly at a single device (e.g., the mobile terminal 10), by a plurality of devices in a distributed fashion (e.g., on one or a plurality of devices in a P2P network) or by devices in a client/server relationship. Furthermore, it should be noted that the devices or elements described below may not be mandatory and thus some may be omitted in a certain embodiment.

Referring now to FIG. 2, the apparatus 50 may include or otherwise be in communication with a processor 70, a user interface 67, a communication interface 74, a memory device 76, a display 85, a mobile application detector 78, a text classifier 88 and a context modeler 89. In one example embodiment, the display 85 may be a touch screen display. The memory device 76 may include, for example, volatile and/or non-volatile memory. For example, the memory device 76 may be an electronic storage device (e.g., a computer readable storage medium) comprising gates configured to store data (e.g., bits) that may be retrievable by a machine (e.g., a computing device like processor 70). In an example embodiment, the memory device 76 may be a tangible memory device that is not transitory. The memory device 76 may be configured to store information, data, files, applications, mobile applications, instructions or the like for enabling the apparatus to carry out various functions in accordance with an example embodiment of the invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content (e.g., pictures, videos, etc.). The memory device 76 may also store one or more taxonomies. The taxonomies may relate to a classification of categories associated with mobile applications and one or more semantic tags. The taxonomies may be arranged in a hierarchy or may be flat.

The apparatus 50 may, in one embodiment, be a mobile terminal (e.g., mobile terminal 10) or a fixed communication device or computing device configured to employ an example embodiment of the invention. However, in one embodiment, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the invention on a single chip or as a single “system on a chip.” As such, in some cases, a chip or chipset may constitute means for performing one or more operations for providing the functionalities described herein. Additionally or alternatively, the chip or chipset may constitute means for enabling user interface navigation with respect to the functionalities and/or services described herein.

The processor 70 may be embodied in a number of different ways. For example, the processor 70 may be embodied as one or more of various processing means such as a coprocessor, microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, or the like. In an example embodiment, the processor 70 may be configured to execute instructions stored in the memory device 76 or otherwise accessible to the processor 70. As such, whether configured by hardware or software methods, or by a combination thereof, the processor 70 may represent an entity (e.g., physically embodied in circuitry) capable of performing operations according to an embodiment of the invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and operations described herein when the instructions are executed. However, in some cases, the processor 70 may be a processor of a specific device (e.g., a mobile terminal or network device) adapted for employing an embodiment of the invention by further configuration of the processor 70 by instructions for performing the algorithms and operations described herein. The processor 70 may include, among other things, a clock, an arithmetic logic unit (ALU) and logic gates configured to support operation of the processor 70.

In an example embodiment, the processor 70 may be configured to operate a connectivity program, such as a browser, a UC browser, Web browser or the like. In this regard, the connectivity program may enable the apparatus 50 to transmit and receive Web content, such as for example location-based content or any other suitable content, according to a Wireless Application Protocol (WAP), for example.

Meanwhile, the communication interface 74 may be any means such as a device or circuitry embodied in either hardware, a computer program product, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (e.g., network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet or other mechanisms.

The user interface 67 may be in communication with the processor 70 to receive an indication of a user input at the user interface 67 and/or to provide an audible, visual, mechanical or other output to the user. As such, the user interface 67 may include, for example, a keyboard, a mouse, a joystick, a display, a touch screen, a microphone, a speaker, or other input/output mechanisms. In an example embodiment in which the apparatus is embodied as a server or some other network devices, the user interface 67 may be limited, remotely located, or eliminated. The processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an example embodiment, the processor 70 may be embodied as, include or otherwise control the mobile application detector, the text classifier and the context modeler. The mobile application detector 78, the text classifier 88 and the context modeler 89 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the mobile application detector 78, the text classifier 88 and the context modeler 89, respectively, as described below. Thus, in an example in which software is employed, a device or circuitry (e.g., the processor 70 in one example) executing the software forms the structure associated with such means.

The mobile application detector 78 may automatically detect and tag one or more mobile applications. In this regard, when a mobile application of the apparatus 50 is selected, launched or executed, the mobile application detector 78 may check whether the mobile application is identified in a predefined mapping list. The predefined mapping list may, but need not be, generated based on input by one or more experts of mobile applications. In this regard, the input may be utilized by the mobile application detector to define the mapping list to include the most popular mobile applications for a number of categories (e.g., communication, business, entertainment, system, etc.). In an instance in which the mobile application detector 78 determines that the selected, launched or executed mobile application is identified in the predefined mapping list, the mobile application detector 78 may output a corresponding semantic tag associated with the mobile application. On the other hand, in an instance in which the mobile application detector 78 determines that the selected, launched or executed mobile application is not identified (e.g., the mobile application is unknown or is unrecognized) in the predefined mapping list, the mobile application detector 78 may submit information (e.g., a name) associated with the mobile application to a network device (e.g., a server, (e.g., communication device 20)) that may search the information and may collect snippets of one or more web pages associated with the information. The snippets may be provided by the network device to the mobile application detector 78 which may utilize the information associated with the snippets to generate a description of the corresponding mobile application. The mobile application detector 78 may then provide the data associated with the generated description to the text classifier 88.

In this regard, the text classifier 88 may assign a semantic tag to the selected, launched or executed mobile application that was not identified in the predefined mapping list based in part on the generated description. The text classifier 88 may include the semantic tag corresponding to the launched or executed mobile application to the predefined mapping list. As such, the text classifier 88 may determine and assign a semantic tag to a mobile application that may be unknown to the mobile application detector 78 based on a description of the mobile application generated by the mobile application detector 78.

The mobile application detector 78 may automatically recognize the corresponding mobile application during an instance in which the mobile application is subsequently selected, launched or executed by the apparatus 50. It should be pointed out that the text classifier 78 may, but need not, operate according to a text classification model such as, for example, a Support Vector Machine (SVM) model, Bayes Networks, Decision Trees or any other suitable text classification model. In an example embodiment, the semantic tag assigned to a mobile application may be determined based on data associated with a taxonomy, as described more fully below.

The context modeler 89 may receive an output of a semantic tag assigned by the text classifier 88 or provided from the predefined application mapping list and may utilize data associated with the semantic tag to determine contextual information associated with the mobile applications of the apparatus 50. For instance, based on utilizing data associated with the semantic tags assigned by the text classifier 88, the context modeler may determine one or more preferences of the user of the apparatus 50, historical usage of mobile applications of the user, data (e.g., other similar mobile applications, corresponding advertisements, etc.) to recommend to the user and any other suitable content. In this regard, the context modeler 89 may dynamically tailor a user's mobile application environment based in part on data associated with semantic tags assigned.

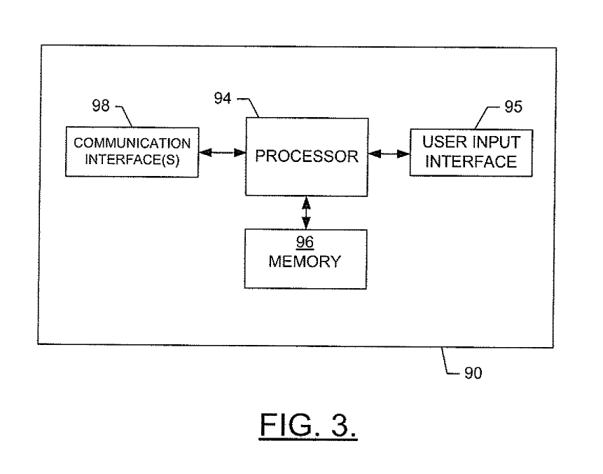

Referring now to FIG. 3, a block diagram of one example of a network device is provided. As shown in FIG. 3, the network device 90 (e.g., a server (e.g., communication device 20)) generally includes a processor 94 and an associated memory 96. The memory 96 may comprise volatile and/or non-volatile memory, and may store content, data and/or the like. For example, the memory may store content, data, information, and/or the like transmitted from, and/or received by, the server. Also for example, the memory 96 may store client applications, instructions, and/or the like for the processor 94 to perform the various operations of the network device in accordance with an embodiment of the invention, as described above.

In addition to the memory 96, the processor 94 may also be connected to at least one interface or other means for displaying, transmitting and/or receiving data, content, and/or the like. In this regard, the interface(s) may comprise at least one communication interface 98 or other means for transmitting and/or receiving data, content, and/or the like, as well as at least one user input interface 95. The user input interface 95, in turn, may comprise any of a number of devices allowing the entity to receive data from a user, such as a keypad, a touch display, a joystick or other input device. In this regard, the processor 94 may comprise user interface circuitry configured to control at least some functions of one or more elements of the user input interface. The processor and/or user interface circuitry of the processor may be configured to control one or more functions of one or more elements of the user interface through computer program instructions (e.g., software and/or firmware) stored on a memory accessible to the processor (e.g., volatile memory, non-volatile memory, and/or the like).

The network device 90 may receive data from one or more devices and may perform a search for the data via a network (e.g., network 30) such as the Internet, for example. For instance, in an example embodiment, the network device 90 may receive data, from the mobile application detector 78, associated with one or more names of mobile applications that may not be included in a mobile application list of the apparatus 50. In this regard, the network device 90 may search a network (e.g., the Internet) for information associated with received indicia (e.g., name(s)) and may provide the search results (e.g., one or more snippets) to the mobile application detector 78 of the apparatus 50.

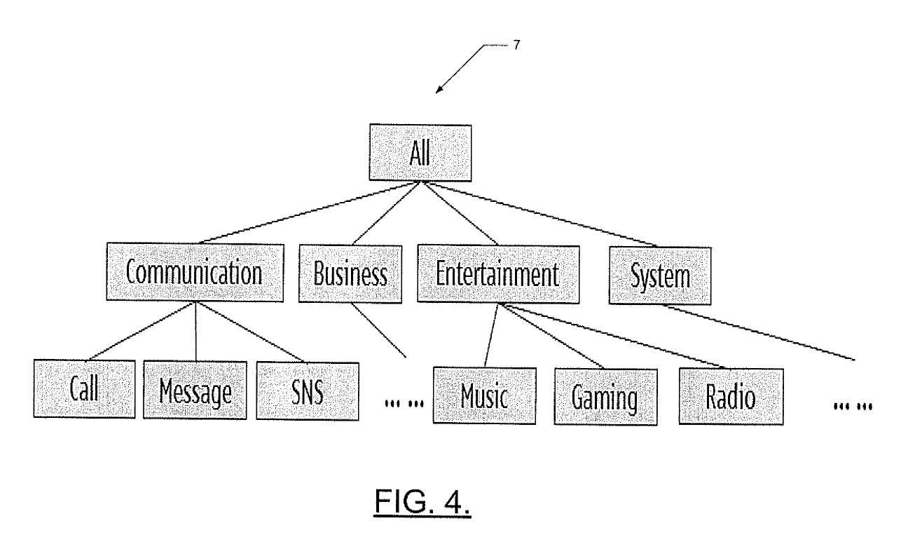

Referring now to FIG. 4, a schematic block diagram of a taxonomy according to an exemplary embodiment is provided. The taxonomy 7 (also referred to herein as mobile application taxonomy 7) may be generated by the mobile application detector 78 based on receipt of data input, via the user interface 67, by one or more mobile application experts (also referred to herein as experts). In this regard, the data input, via the user interface 67, by one or more of the experts may be based on the most popular mobile applications for various categories (e.g., communication, business, entertainment, system, call, message, social network service (SNS), music, gaming, radio, etc.). In the example embodiment of FIG. 4 some of the categories may be subsets of other categories. For instance, the call, message and SNS categories may be subsets of the communication category. Additionally, the music, gaming and radio categories may be subsets of the entertainment category. Also, in the example of FIG. 4, each of the categories may correspond to a node (also referred to herein as leaf node). Additionally, each node of the taxonomy 7 may correspond to or may denote a semantic tag to identify corresponding mobile applications that belong to the corresponding node.

In an example embodiment, one or more of the most popular mobile applications may belong to or be associated with each leaf node or category of the taxonomy 7 based on receipt of data input, by the experts, via the user interface 67. For instance, in one example embodiment, the most popular mobile applications for the music category may be Music Player, Pandora Radio™, GGMusic, and Tian Tian Pod (TTPod) mobile applications, etc. However, any other suitable mobile applications may be associated with the music category or any other categories.

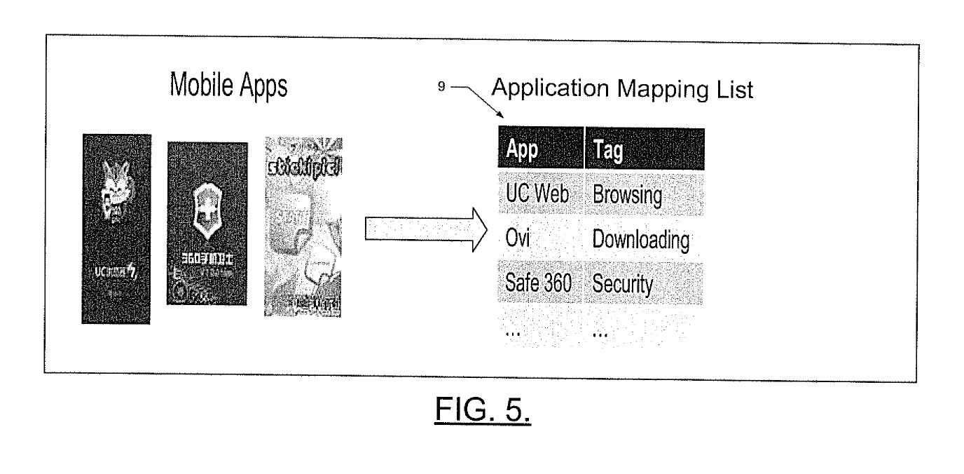

The taxonomy 7 may be defined to ensure that any mobile application(s) may be assigned into one leaf node of the taxonomy. Based in part on the data associated with the taxonomy 7, the mobile application detector 78 may generate an application mapping list (e.g., application mapping list 9 of FIG. 5) by extracting data associated with the one or more mobile applications associated with each leaf node of the taxonomy 7, as described more fully below.

Although not shown in FIG. 4, it should be pointed out that one or more other categories or semantic tags may be part of the taxonomy 7 without departing from the spirit and scope of the invention. For instance, categories associated with browsing, downloading and security, etc. may also be part of the taxonomy 7.

Referring now to FIG. 5, an illustration of an application mapping list according to an example embodiment is provided. The application mapping list 9 may be generated by the mobile application detector 78 by extracting the mobile applications associated with each leaf node of a taxonomy (e.g., taxonomy 7). In the example embodiment of FIG. 5, the mobile application detector 78 may analyze data associated with a taxonomy and determine that mobile applications (also referred to herein as mobile apps) of a taxonomy correspond to UC Web, Ovi and Safe 360 mobile applications. Additionally, the mobile application detector 78 may analyze data associated with the taxonomy and determine that the UC Web mobile application belongs to or is associated with a Browsing leaf node or category. In this regard, the mobile application detector 78 may assign a semantic tag (also referred to herein as tag) to the UC Web mobile application based on the name of the corresponding leaf node or category (e.g., Browsing) that the UC Web mobile application belongs to. As such, the mobile application detector 78 may assign the semantic tag, associated with the UC Web, as Browsing and may include this information in the application mapping list 9. The mobile application detector 78 may also analyze data associated with the taxonomy and determine that the Ovi mobile application belongs to or is associated with a Downloading leaf node or category. In this manner, the mobile application detector 78 may assign a semantic tag to the Ovi mobile application based on a name of the corresponding leaf node or category (e.g., Downloading) that the Ovi mobile application belongs to. As such, the mobile application detector 78 may assign a semantic tag, associated with the Ovi mobile application, as Downloading and may include this information in the application mapping list 9.

Additionally, the mobile application detector 78 may analyze data of the taxonomy and may determine that the Safe 360 mobile application belongs to or is associated with a Security leaf node or category. In this manner, the mobile application detector 78 may assign a semantic tag to the Safe 360 mobile application based on a name of the corresponding leaf node or category (e.g., Security) that the Safe 360 mobile application belongs to. As such, the mobile application detector 78 may assign a semantic tag, associated with the Safe 360 mobile application, as Security and may include this information in the application mapping list 9.

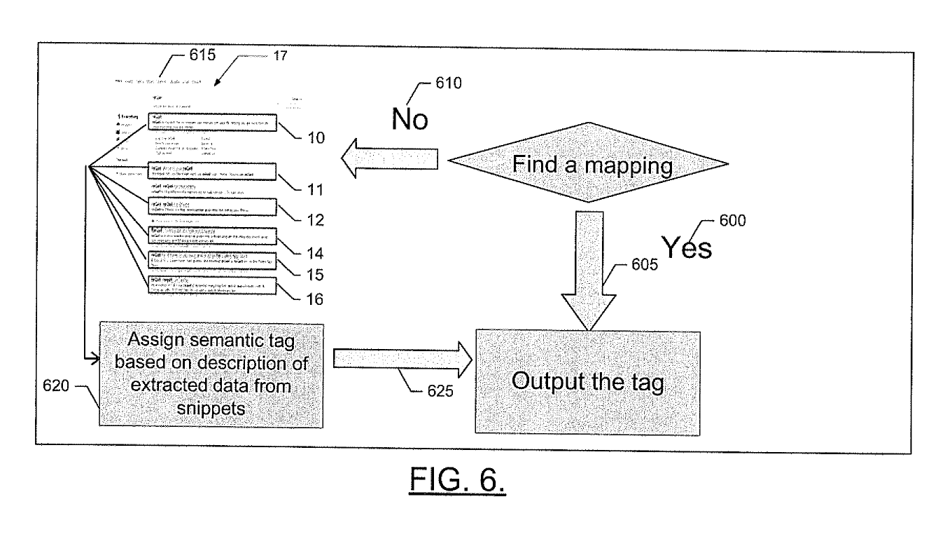

Referring to FIG. 6, an illustration of an example embodiment for recognizing one or mobile applications is provided. For purposes of illustration and not of limitation consider an example in which mobile application detector 78 receives indications that a mobile application is selected by a user of apparatus 50. In this regard, the mobile application detector 78 may determine whether the selected mobile application is identified in the application mapping list 9. In this example, presume that the mobile application detector 78 determines that the selected mobile application corresponds to the Safe 360 mobile application. As such, the mobile application detector 78 may analyze data in the application mapping list 9 and may determine that the Safe 360 mobile application is identified or mapped in the application mapping list 9. (See Operation 600) In response to the mobile application detector 78 determining that the Safe 360 mobile application is identified in the application mapping list, the mobile application detector 78 may output a semantic tag (e.g., a Security semantic tag) associated with the Safe 360 mobile application to the context modeler 89. (See Operation 605) The context modeler 89 may, but need not, utilize the information associated with the semantic tag to determine one or more preferences or interests of the user.

For purposes of illustration and not of limitation the context modeler 89 may provide other similar security mobile applications to the display 85 for consideration by the user or may provide corresponding advertisements or any other suitable information associated with the output of the semantic tag for consideration by the user. The context modeler 89 may also send the information associated with the semantic tag (e.g., the Security semantic tag) to the network device 90 and may request the network device 90 to provide the context modeler 89 with one or more recommendations (e.g., other similar mobile applications, advertisements, etc.) associated with the semantic tag that may be provided to the display 85 for consideration by the user of the apparatus.

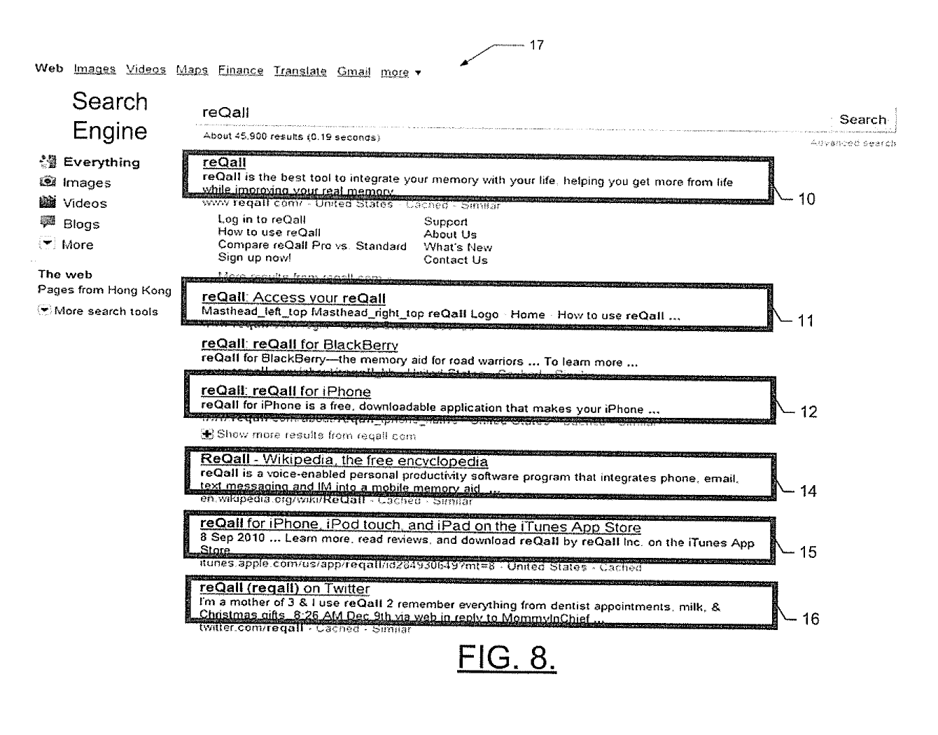

Presume further that the mobile application detector 78 receives an indication of another selection of a different mobile application. For instance, presume that the mobile application detector 78 receives a selection of a mobile application named reQall™. The reQall™ mobile application may be associated with a reminder tool. The mobile application detector 78 may analyze data in the application mapping list 9 and may determine that this newly detected mobile application is not identified in the application mapping list 9. (See Operation 610) As such, the mobile application detector 78 may provide indicia (e.g., the name, associated with the reQall™ mobile application, to the network device 90 and may request the network device 90 to search the indicia (e.g., name) of the mobile application. (See Operation 615) In this regard, the network device 90 may search the name of the mobile application reQall™ via a network (e.g., the Internet). In an example embodiment, the network device 90 may utilize one or more search engines (e.g., a Google search engine, Bing search engine, etc.) to search the name of the mobile application reQall™. Based on receipt of the search results 17 (e.g., search results of a Web page (See e.g., FIG. 8)), the network device 90 may provide one or more snippets (e.g., snippets 10, 11, 12, 14, 15, 16) of the search results to the mobile application detector 78. The snippets may be associated with data relating to a summary of a search result(s) related to a mobile application(s) that may not be identified in the application mapping list 9.

In response to receipt of the snippets from the network device 90, the mobile application detector 78 may extract data from the snippets and may utilize the extracted data to generate a description (e.g., a short description) of the corresponding mobile application, which is reQall™, in this example. In the example of FIG. 6, the mobile application detector 78 may extract data from snippets (e.g., snippets 10, 11, 12, 14, 15, 16) including, but not limited to, information associated with memory, reminders, that reQall™ corresponds to a phone application, etc. In this regard, as an example, the mobile application detector 78 may generate a description such as for example “a reminder mobile application”. The mobile application detector 78 may provide the data associated with the description to the text classifier 88 and based on analyzing data associated with one or more keywords of the description, the text classifier 88 may assign a semantic tag to the mobile application reQall™. (See Operation 620)

In the embodiment of FIG. 6, as an example, the text classifier 88 may assign a semantic tag such as “Reminder” to the reQall™ mobile application based on analyzing data of the description. The text classifier 88 may output the assigned semantic tag “Reminder”. (See Operation 625) The text classifier 88 may output the semantic tag “Reminder” to the context modeler 89. The context modeler 89 may utilize the information associated with the semantic tag to determine the types of mobile applications that the user of the apparatus 50 most frequently utilizes, the history of the user's mobile application usage, one or more personal preferences of the user of the apparatus 50 and any other suitable information that may be determined based in part on analyzing the semantic tag.

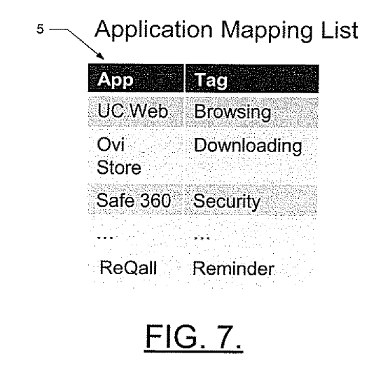

In this regard, the context modeler 89 may but need not, enable provision of display, via display 85, of one or more similar mobile applications for consideration by the user. Additionally, the text classifier 88 may also update the application mapping list 9 to obtain a new or updated application mapping list 5 by including the assigned semantic tag “Reminder” in application mapping list 5 which may be associated with the reQall™ mobile application, as shown in FIG. 7. In an example embodiment, a user of the apparatus 50 may utilize the user interface 67 to edit the semantic tag if the user determines that the semantic tag assigned by the text classifier 88 is incorrect. By analyzing the data in the application mapping list 5 relating to the reQall™ mobile application along with data associated with the semantic tag “Reminder”, the mobile application detector 78 may be able to automatically recognize the reQall™ mobile application in an instance in which the mobile application detector 78 receives an indication of a subsequent selection of the reQall™ application.

Referring now to FIG. 8, an example embodiment of a diagram illustrating snippets in the search results of a Web page is provided. In the example of FIG. 8, the network device 90 may provide the mobile application detector 78 with a Web page of search results 17 based on a search of indicia (e.g., the name reQall). In this regard, the mobile application detector 78 may analyze the data associated with the search results and may determine one or more snippets from which data may be extracted to obtain a description associated with the reQall™ mobile application. In the example embodiment of FIG. 8, the mobile application detector 78 may utilize snippets 10, 11, 12, 14, 15, 16 associated with the search results of the Web page to generate the description associated with the reQall™ mobile application. The mobile application detector 78 may utilize a predetermined threshold (e.g., five, six, ten, etc.) of snippets to generate a description of a mobile application (e.g., the reQall™ mobile application).

Additionally, in order to meet the predetermined threshold, the mobile application detector 78 may consider the relevancy of data associated with a snippet(s). In this regard, the mobile application detector 78 may analyze data corresponding to one or more keywords associated with a candidate snippet. In an instance in which the mobile application detector 78 determines that a candidate snippet is associated with data corresponding to one or more keywords, the mobile application detector 78 may select the candidate snippet for consideration. On the other hand, in an instance in which the mobile application detector 78 determines that a candidate snippet is not associated with data corresponding to one or more keywords, the mobile application detector 78 may remove the candidate snippet from consideration.

In the example embodiment of FIG. 8, for purposes of illustration and not of limitation, the predetermined threshold of snippets may be six and the mobile application detector 78 may determine that each of the snippets 10, 11, 12, 14, 15, and 16 are associated with one or more keywords. As such, the mobile application detector 78 may determine that the snippets 10, 11, 12, 14, 15 and 16 are relevant.

It should be pointed out that in an alternative example embodiment in an instance in which the taxonomy 7 is being defined, the mobile application detector 78 may examine each leaf node of the taxonomy and may submit indicia (e.g., the names) associated with corresponding mobile applications to network device 90 requesting the network device 90 to search the indicia (e.g., the names) associated with the mobile applications. Based on receipt of the search results from the network device 90, the mobile application detector 78 may extract one or more snippets from the search results and generate descriptions for each of the mobile applications. The text classifier 88 may analyze the descriptions in order to assign a name to each of the leaf nodes (e.g., categories) of the taxonomy 7. In this example embodiment, the names of each of the leaf nodes may correspond to semantic tags.

In an example embodiment, the mobile application detector 78 may preprocess extracted snippets for: (1) removing one or more stop words such as, for example, “a”, “an”, “the”, “of”, etc.; (2) removing the particular mobile application names for the generality of representing an entire category of mobile applications; and (3) normalizing words in a manner such as, for example, “health” and “healthy”, “walk” and “walking” or the like.

In an example embodiment, the mobile application detector 78 may recognize cross-language mobile applications. As referred to herein, cross language mobile applications may be mobile applications that are capable of operating in more than one language. For purposes of illustration and not of limitation, a mobile application may be capable of operating in the English language and in a Chinese language. In an instance in which the mobile application detector 78 determines that a name of a mobile application, which may not be identified in the application mapping list 9, is in the English language, the mobile application detector 78 may request the network device 90 to perform a search associated with the name by utilizing one or more English based search engines (e.g., a Google search engine, a Bing search engine, etc.). In this regard, the text classifier 88 may recognize the language of the description generated by the mobile application detector 78 based on extraction of data from one or more snippets corresponding to search results provided by the network device 90. As such, the text classifier 88 may assign a semantic tag to the cross language application. The text classifier 88 may assign the semantic tag to the cross language application in the language of the name of the mobile application that was searched, which is English in this example.

Additionally, in an instance in which the mobile application detector 78 determines that a name of the same mobile application is in Chinese language and may not be identified in the application mapping list 9, the mobile application detector 78 may request the network device 90 to perform a search associated with the name by utilizing a Chinese-based search engine (e.g., a soso search engine, a Baidu search engine, etc). In this manner, the text classifier 88 may recognize the language of the description generated by the mobile application detector 78 based on extraction of data from one or more snippets corresponding to search results provided by the network device 90. As such, the text classifier 88 may assign a semantic tag to the cross language mobile application. The text classifier 88 may assign the semantic tag to the cross language mobile application in the language of the name of the mobile application that was searched, which is a Chinese language in this example. In an example embodiment, the text classifier 88 may be configured to assign semantic tags for each major language.

In an example embodiment, in an instance in which the mobile application detector 78 recognizes that a new or previously unrecognized mobile application is included in an application mapping list (e.g., application mapping list 5) the mobile application detector 78 may send this application mapping list to the network device 90 and the network device 90 may update a global application mapping list on the basis of the new mobile application and its corresponding semantic tag identified in the received application mapping list. In this regard, the network device 90 may be configured to incorporate the newly detected mobile applications that are assigned semantic tags received from apparatuses 50 of multiple users into a global application mapping list maintained by the network device 90. In response to receipt of a newly identified mobile application(s) and a corresponding assigned semantic tag(s), the network device 90 may send the updated global application mapping list to one or more apparatuses 50 that may be unaware of the mobile application(s). These apparatuses 50 may updated their application mapping list to include the newly identified mobile application(s) and the corresponding assigned semantic tag(s). In this regard, one or more other apparatuses 50 may automatically recognize the newly identified mobile application(s).

In an example embodiment, the network device 90 may generate one or more correlations between mobile applications based on detected uses of similar mobile applications of users. By utilizing data associated with the preferences of users which may be generated based in part on analyzing semantic tags associated with mobile applications, the network device 90 may recommend similar mobile applications, advertisements or other corresponding data to apparatuses 50 of users for consideration. Data associated with the preferences of users may be provided to the network device 90 by one or more of the apparatuses 50.

Additionally, the network device 90 may examine one or more profiles of social network services (e.g., Facebook™, Twitter™, etc.) and may recommend one or more mobile applications to apparatuses 50 of users based on the mobile applications maintained by the apparatuses 50 of one or more users that may be part of a corresponding friends list. In this regard, the network device 90, for example, may determine that User A and User B are friends of a social network service and that an apparatus 50 of User B has a mobile application that an apparatus 50 of User A does not have. As such, the network device 90 may send data to the apparatus 50 of User A recommending the mobile application that apparatus 50 of User A does not have.

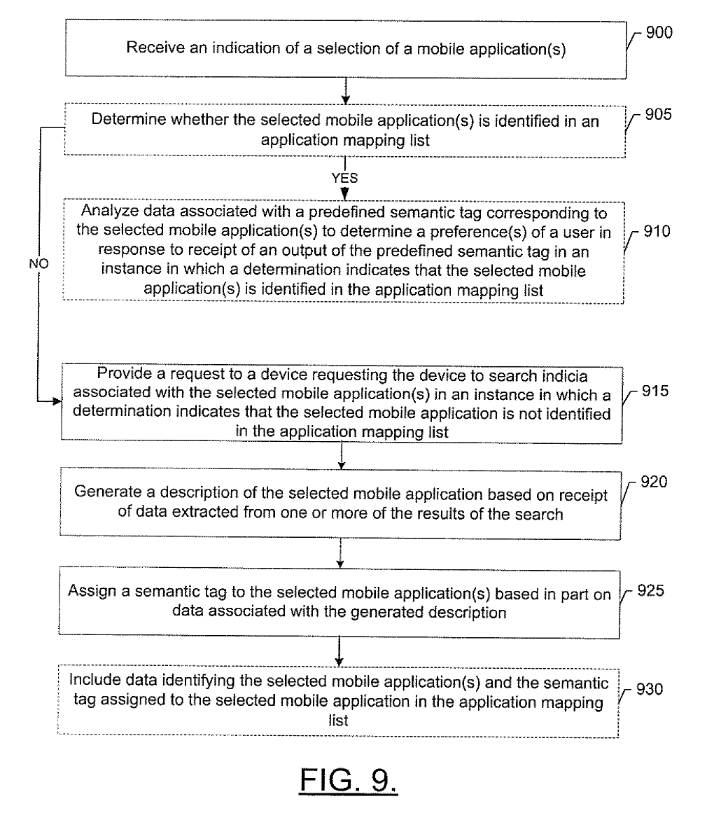

Referring now to FIG. 9 an example embodiment of a flowchart for automatically recognizing one or more mobile applications is provided. At operation 900, an apparatus (e.g., apparatus 50) may receive an indication of a selection of a mobile application(s). The selected mobile application(s) may be currently executed by the apparatus. Optionally, at operation 905, the apparatus may determine whether the selected mobile application(s) is identified in an application mapping list (e.g., application mapping list 9). Optionally, at operation 910, the apparatus 50 may analyze data associated with a predefined semantic tag corresponding to the selected mobile application to determine one or more preferences of a user in response to receipt of an output of the predefined semantic tag in an instance in a determination indicates that the selected mobile application(s) is identified in the application mapping list.

At operation 915, the apparatus may provide a request, or a message, to a device requesting the device to search indicia (e.g., a name(s)) associated with the selected mobile application(s) in an instance in which a determination indicates that the selected mobile application(s) is not identified in the application mapping list. Optionally, at operation 920, the apparatus may generate a description of the selected mobile application(s) based on receipt of content extracted from one or more results of the search. The data may be extracted from one or more snippets of a received Web page. At operation 925, the apparatus may assign a semantic tag to the selected mobile application(s). The assignment of the semantic tag to the selected mobile application(s) may be based in part on analyzing data associated with the description of the selected mobile application(s). Optionally, at operation 930, the apparatus may include data indicating the selected mobile application(s) and the semantic tag assigned to the selected mobile application(s) in application mapping list. In this regard, the application mapping list may be a new or updated application mapping list (e.g., application mapping list 5).

It should be pointed out that FIG. 9 is a flowchart of a system, method and computer program product according to an example embodiment of the invention. It will be understood that each block of the flowchart, and combinations of blocks in the flowchart, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory device 76, memory 96) and executed by a processor (e.g., processor 70, processor 94 mobile application detector 78, text classifier 88, context modeler 89). As will be appreciated, any such computer program instructions may be loaded onto a computer or other programmable apparatus (e.g., hardware) to produce a machine, such that the instructions which execute on the computer or other programmable apparatus cause the functions specified in the flowchart blocks to be implemented. In one embodiment, the computer program instructions are stored in a computer-readable memory that can direct a computer or other programmable apparatus to function in a particular manner, such that the instructions stored in the computer-readable memory produce an article of manufacture including instructions which implement the function(s) specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart blocks.

Accordingly, blocks of the flowchart support combinations of means for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In an example embodiment, an apparatus for performing the method of FIG. 9 above may comprise a processor (e.g., the processor 70, the processor 94, the mapping application detector 78, the text classifier 88, the context modeler 89) configured to perform some or each of the operations (900-930) described above. The processor may, for example, be configured to perform the operations (900-930) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (900-930) may comprise, for example, the processor 70 (e.g., as means for performing any of the operations described above), the processor 94, the mapping application detector 78, the text classifier 88, the context modeler 89 and/or a device or circuitry for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-24. (canceled)

25. A method comprising:
receiving an indication of a selection of at least one mobile application;
enabling provision of a request, to a device, requesting the device to search indicia associated with the selected mobile application in an instance in which a determination indicates that the selected mobile application is not identified in an application mapping list; and
assigning, via a processor, a semantic tag to the selected mobile application based in part on data associated with a description generated based in part by extracting content from one or more results of the search.

26. The method of claim 25, further comprising;
enabling inclusion of data identifying the selected mobile application and the assigned semantic tag in the application mapping list to obtain an updated application mapping list.

27. The method of claim 25, wherein prior to enabling provision, the method further comprises:
determining whether the selected mobile application is identified in the application mapping list; and
analyzing data associated with a predefined semantic tag corresponding to the selected mobile application to determine one or more preferences of a user in an instance in which a determination indicates that the selected mobile application is identified in the application mapping list.

28. The method of claim 25, further comprising:
determining that the content comprises one or more snippets corresponding to summaries of data determined to be relevant to the indicia; and
determining that the description describes the selected mobile application.

29. The method of claim 25, further comprising:
enabling provision of data to the device associated with one or more preferences of a user based on analyzing content associated with the assigned semantic tag; and
receiving one or more recommendations from the device requesting the user to consider receipt of content related to the assigned semantic tag.

30. The method of claim 25, wherein:
the assigned semantic tag corresponds to at least one of a leaf node or a category of a taxonomy, and
the application mapping list comprises data indicating one or more mobile applications that are associated with one or more respective semantic tags.

31. The method of claim 26, further comprising:
automatically recognizing the selected mobile application in response to receipt of a subsequent indication of another selection of the selected mobile application based in part on analyzing information in the updated application mapping list.

32. The method of claim 26, further comprising:
analyzing data associated with the assigned semantic tag to determine one or more preferences of a user; and
enabling provision of display of one or more recommendations for consideration by the user based in part on information associated with the preferences.

33. The method of claim 26, further comprising:
enabling provision of the updated application mapping list to the device which utilizes at least a portion of data corresponding to one or more newly recognized mobile applications of the updated application mapping list to update a global application mapping list maintained by the device to enable sending of information associated with the newly recognized mobile applications to one or more apparatuses for inclusion in respective application mapping lists of the apparatuses.

34. An apparatus comprising:
at least one processor: and
at least one memory including computer program code, the at least one memory and the computer program code configured to, with the at least one processor, cause the apparatus to perform at least the following:
receive an indication of a selection of at least one mobile application;
enable provision of a request, to a device, requesting the device to search indicia associated with the selected mobile application in an instance in which a determination indicates that the selected mobile application is not identified in an application mapping list; and
assign a semantic tag to the selected mobile application based in part on data associated with a description generated based in part by extracting content from one or more results of the search.

35. The apparatus of claim 34, wherein the at least one memory and the computer program code are further configured to, with the processor, cause the apparatus to:
enable inclusion of data identifying the selected mobile application and the assigned semantic tag in the application mapping list to obtain an updated application mapping list.

36. The apparatus of claim 34, wherein prior to the inclusion of the data, the at least one memory and the computer program code are further configured to, with the processor, cause the apparatus to:
determine whether the selected mobile application is identified in the application mapping list; and
analyze data associated with a predefined semantic tag corresponding to the selected mobile application to determine one or more preferences of a user in an instance in which a determination indicates that the selected mobile application is identified in the application mapping list.

37. The apparatus of claim 34, wherein the at least one memory and the computer program code are further configured to, with the processor, cause the apparatus to:
determine that the content comprises one or more snippets corresponding to summaries of data determined to be relevant to the indicia; and
determine that the description describes the selected mobile application.

38. The apparatus of claim 34, wherein the at least one memory and the computer program code are further configured to, with the processor, cause the apparatus to:
enable provision of data to the device associated with one or more preferences of a user based on analyzing content associated with the assigned semantic tag; and
receive one or more recommendations from the device requesting the user to consider receipt of content related to the assigned semantic tag.

39. The apparatus of claim 34, wherein:
the assigned semantic tag corresponds to at least one of a leaf node or a category of a taxonomy, and
the application mapping list comprises data indicating one or more mobile applications that are associated with one or more respective semantic tags.

40. The apparatus of claim 35, wherein the at least one memory and the computer program code are further configured to, with the processor, cause the apparatus to:
automatically recognize the selected mobile application in response to receipt of a subsequent indication of another selection of the selected mobile application based in part on analyzing information in the updated application mapping list.

41. The apparatus of claim 35, wherein the at least one memory and the computer program code are further configured to, with the processor, cause the apparatus to:
analyze data associated with the assigned semantic tag to determine one or more preferences of a user; and
enable provision of display of one or more recommendations for consideration by the user based in part on information associated with the preferences.

42. The apparatus of claim 35, wherein the at least one memory and the computer program code are further configured to, with the processor, cause the apparatus to:
enable provision of the updated application mapping list to the device which utilizes at least a portion of data corresponding to one or more newly recognized mobile applications of the updated application mapping list to update a global application mapping list maintained by the device to enable sending of information associated with the newly recognized mobile applications to one or more apparatuses for inclusion in respective application mapping lists of the apparatuses.

43. A computer program product comprising at least one computer-readable storage medium having computer-executable program code instructions stored therein, the computer-executable program code instructions comprising:
program code instructions configured to enable receipt of an indication of a selection of at least one mobile application;
program code instructions configured to enable provision of a request, to a device, requesting the device to search indicia associated with the selected mobile application in an instance in which a determination indicates that the selected mobile application is not identified in an application mapping list; and
program code instructions configured to assign a semantic tag to the selected mobile application based in part on data associated with a description generated based in part by extracting content from one or more results of the search.

44. A method comprising:
receiving an updated application mapping list from a device;
utilizing, via a processor, at least a portion of data corresponding to one or more newly recognized mobile applications of the updated application mapping list to update a global mapping list; and
enabling provision of information associated with the newly recognized mobile applications, to one or more devices, for inclusion in respective application mapping lists of the devices.

45. The method of claim 44, further comprising:
receiving data associated with one or more preferences of users of the devices generated based in part on analyzing semantic tags associated with mobile applications;
generating one or more recommendations associated with similar mobile applications, or other content, related to the semantic tags based in part on the data associated with the preferences; and
enabling provision of at least one of the recommendations to at least one of the devices for consideration of a user of the at least one device,
wherein the updated application mapping list comprises data identifying at least one selected mobile application and at least one corresponding assigned semantic tag that was previously unidentified in an application mapping list.

46. An apparatus comprising:
at least one processor; and
at least one memory including computer program code, the at least one memory and the computer program code configured to, with the at least one processor, cause the apparatus to perform at least the following:
receive an updated application mapping list from a device;
utilize at least a portion of data corresponding to one or more newly recognized mobile applications of the updated application mapping list to update a global mapping list; and
enable provision of information associated with the newly recognized mobile applications, to one or more devices, for inclusion in respective application mapping lists of the devices.

47. The apparatus of claim 46, wherein the at least one memory and the computer program code are further configured to, with the processor, cause the apparatus to:
receive data associated with one or more preferences of users of the devices generated based in part on analyzing semantic tags associated with mobile applications;
generate one or more recommendations associated with similar mobile applications, or other content, related to the semantic tags based in part on the data associated with the preferences; and
enable provision of at least one of the recommendations to at least one of the devices for consideration of a user of the at least one device,
wherein the updated application mapping list comprises data identifying at least one selected mobile application and at least one corresponding assigned semantic tag that was previously unidentified in an application mapping list.
